(19) United States
(12) Patent Application Publication
(10) Pub. No.: US 2017/0148097 A1
(43) Pub. Date: May 25, 2017

(54) SYSTEMS AND METHODS FOR DERIVING FINANCIAL INFORMATION FROM EMOTIONAL CONTENT ANALYSIS

(71) Applicant: Indiana University Research and Technology Corporation, Indianapolis, IN (US)

(72) Inventors: Alan Dennis, Bloomington, IN (US); Hong Kee Sul, Bloomington, IN (US); Lingyao Yuan, Ankeny, IA (US)

(73) Assignee: Indiana University Research and Technology Corporation, Indianapolis, IN (US)

(21) Appl. No.: 15/355,992

(22) Filed: Nov. 18, 2016

Related U.S. Application Data
(60) Provisional application No. 62/258,761, filed on Nov. 23, 2015.

(51) Int. Cl. G06Q 40/06; G06Q 50/00

(52) U.S. Cl. CPC G06Q 40/06; G06Q 50/01

(57) ABSTRACT

Method of deriving financial information comprising gathering, by a processor, information from a plurality of social media accounts, associating, by the processor, the information from the plurality of social media accounts with a firm, determining an excitement value for the information gathered from each of the plurality of social media accounts, and estimating an overall excitement value for the firm are disclosed. Systems are also disclosed.

### CROSS-REFERENCE TO RELATED APPLICATIONS

This application claims priority to U.S. Provisional Application Ser. No. 62/258,761, entitled SYSTEMS AND METHODS FOR DERIVING FINANCIAL INFORMATION FROM EMOTIONAL CONTENT ANALYSIS, filed on Nov. 23, 2015, the entire disclosure of which is hereby expressly incorporated by reference.

### FIELD OF THE DISCLOSURE

This disclosure relates to the derivation of financial information from social media. More specifically, this disclosure relates to systems and methods for deriving financial information from social media accounts having less than 1,000 followers.

### BACKGROUND

Social media has become an important part of many people's lives, including investment decision making. While much decision making is based on the rational assessment of information, emotional sentiment also plays a significant role. Sentiment can be contagious, so it can be shared among individuals, either face-to-face or through social media.

In 2014, almost 75% of adult Internet users use social media and this percentage is increasing. Not only has the number of people using social media (e.g., TWITTER, FACEBOOK, LINKEDIN, YOUTUBE, PINTEREST, and INSTAGRAM) increased dramatically, so too has the amount of use. In 2015, there were about 300 million TWITTER users worldwide who sent an average of 500 million TWEETS per day. Many users of social media (“users”) have integrated social media into many aspects of their daily life, including investment decision making. Numerous professional and amateur investors and analysts use social media services—like TWITTER—to post news articles, and opinions, often providing information and comments more frequently than the professional news media.

Stock returns (the profits from trading stocks) are influenced by many factors. Along with fundamental factors (e.g., earning base, valuation multiple) and technical factors (e.g., transactions, trends), market sentiment (e.g., positive emotions) also plays an important role in influencing stock returns. Market sentiment can be expressed in various ways. The development of social media provides a new meaningful channel for users to share information and their personal feelings. As such, it also serves as a convenient avenue to capture market sentiment.

Conventional research has studied whether the emotional content of TWEETS can be used to predict stock returns, including assessing the emotional state (calm, alert, sure, vital, kind, and happy) in 10 million TWEETS that were not related to the stock market. They found that the amount of one state, “calm,” was significantly positively correlated with changes in the Dow Jones Industrial average (“DJIA”) several days later; in other words, when there was a great deal of “calm” information in social media on a given day, the DJIA tended to rise over the following days.

Other research examined 200,000 TWEETS from STOCKTWITS that focused on specific stocks and classified each TWEET (using machine learning) as “bullish,” “bearish,” or “neutral” to create a “buillishness” index for each stock. They found the five-day rolling average of the bullishness index was useful in predicting stock price movements.

Other conventional research used machine learning to create a different bullishness index, that they too found to be somewhat predictive of stock returns several days later. Other conventional research used machine learning to examine the sentiment (e.g., positive emotion) expressed information in social media and found it to be preditive of stock returns several days later.

Additional conventional research examined emotional states (happiness, affection, satisfaction. fear, anger, depression, contempt) and positive and negative sentiment and found negative sentiment and “depression” to predict stock returns on the following day.

While conventional research and findings are promising in suggesting that the emotional state and sentiment expressed information in social media can be used to predict aggregate stock returns, methods and systems for better collecting and analyzing emotional states and sentiments expressed in social media is needed.

A need therefore exists to address issues of emotional state and sentiment when analyzing financial information of firms and industries.

### SUMMARY

In various embodiments, methods of deriving financial information may include gathering, by a processor, information from a plurality of social media accounts, associating, by the processor, the information from the plurality of social media accounts with a firm, determining an excitement value for the information gathered from each of the plurality of social media accounts, and estimating an overall excitement value for the firm.

In some embodiments, systems for deriving financial information may include a processor in electrical communication with a tangible, non-transitory memory having instructions that, in response to execution by the processor, cause the processor to gather information from a plurality of social media accounts, associate the information from the plurality of social media accounts with a firm, determine an excitement value for the information gathered from each of the plurality of social media accounts, and estimate an overall excitement value for the firm.

### BRIEF DESCRIPTION OF THE DRAWINGS

The above mentioned and other features and objects of this disclosure, and the manner of attaining them, will become more apparent and the disclosure itself will be better understood by reference to the following description of various embodiments of the disclosure taken in conjunction with the accompanying drawings, wherein:

FIG. 1A is a flowchart of a method of deriving financial information according to various embodiments;

FIG. 1B is a diagram of a system according to various embodiments;

FIG. 2 is a table illustrating stock ticker information;

FIG. 3 is a table containing earning and sentiment information;

FIG. 4A is a table containing sentiment information split using 171 followers and using 1,000 followers;

FIG. 4B is a table containing sentiment information split using 171 followers and using 1,000 followers using POS2;

FIG. 4C is a table containing sentiment information split using 171 followers and using 1,000 followers using POS2;

FIG. 5A is a table containing sentiment information using POS1;

FIG. 5B is a table containing sentiment information using POS2;

FIG. 5C is a table containing sentiment information using POS3;

FIG. 6 is a table showing average returns for various holding periods using methods according to various embodiments;

FIG. 7A is a graph of TWEETS by day of the week according to various embodiments; and

FIG. 7B is a graph of TWEETS by day of the week according to various embodiments.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplification set out herein illustrates various embodiments of the disclosure, in one form, and such exemplifications are not to be construed as limiting the scope of the disclosure in any manner.

### DETAILED DESCRIPTION

The embodiments disclosed below are not intended to be exhaustive or limit the disclosure to the precise form disclosed in the following detailed description. Rather, the embodiments are chosen and described so that others skilled in the art may utilize their teachings.

One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower level programming language.

Many embodiments disclosed herein may be understood through a contagion perspective from social psychology when determining how social media (e.g., TWEETS) are linked to future stock returns. Under this perspective, sentiment influences stock prices as it spreads through the investing public. Sentiment that spreads quickly has an immediate influence on prices, while sentiment that spreads more slowly has a slower effect. Sentiment that spreads slowly opens the door for a trading strategy that capitalizes on the stock returns from slowly rising or falling prices.

The results illustrated herein include analysis of more than a year's worth of data collected from TWITTER and linked it to the average daily stock returns of firms in the S&P 500. The results from various embodiments help to illustrate that the sentiment information in social media about specific firms was significantly related to stock returns on subsequent days. For example, TWEETS from individuals with fewer followers had a stronger impact on future returns than TWEETS from those with many followers (because their TWEETS took longer to spread than TWEETS from those with many followers).

Also analyzed and included in various embodiments is the accounting for whether information in social media was passed on by others (e.g., if a TWEET was retweeted). The TWEETS that were not retweeted took longer to spread and, thus, were also linked to greater future stock return predictability.

Accordingly, the sentiment contained in information in social media, such as TWEETS, may have a direct effect on stock market returns in a manner similar to the effects that professional news media have on returns. Positive sentiment should be associated with positive abnormal returns and negative sentiment should be associated with negative abnormal returns.

The effects of sentiment spread in the same manner in which information spreads through the investing public. Thus, the speed of diffusion of information in social media is important. If a TWEET about a specific firm is sent by a user who has many followers, the sentiment it contains will spread faster than the sentiment sent by a user who has few followers, because more individuals will see it immediately. Sentiment contained in information in social media from those with fewer followers will take longer to disseminate because fewer people will see them immediately. Thus, the number of followers may affect the speed of sentiment dissemination.

Sentiment that is spread more quickly will be incorporated into prices faster, so that it will have an effect on returns sooner. Its effects are more likely to be seen immediately (e.g., the same trading day on which it was tweeted). Thus, sentiment that is spread quickly will have little effect on future abnormal returns, because it effects are immediately incorporated into prices.

In contrast, less visible sentiment that is spread more slowly will take longer to affect stock prices. Therefore, sentiment that is spread more slowly will have a larger effect on future abnormal returns. Thus, various systems and methods disclosed herein are able to use sentiment information in social media about a specific firm sent by individuals with few followers and may help to generate future abnormal returns.

This sentiment dissemination process will also be affected by the extent to which information in social media is shared. While specific examples used herein may refer to various specific forms of social media, the disclosure is not particularly limited to only specific forms of social media and may include any past, present, or future forms of social media. As used herein, the term “retweeted” may be understood to include the sharing, reposting, or indication of agreement with social media, such as sharing a TWEET. Thus, when TWEETS are “retweeted” (i.e., when an individual who receives a TWEET, resends it to his or her followers) the diffusion process may be affected. A study of 37 billion public TWEETS found that the percentage of retweets (TWEETS that have been resent by someone other than the originating author) has increased over time: about 5% in 2010, 10% in 2011, 20% in 2012 and 25% in 2013.

Individuals retweet for a variety of reasons. The most common reasons are because they believe the TWEETS's information would be of interest to their followers or to express support for the original Twitterer (someone that TWEETS). In the stock investing context (where TWEETS are deliberately tagged with the $ and ticker symbol), most TWEETS are retweeted because the sender believes they have potential information for other investors.

RETWEETS affect the diffusion process. RETWEETING someone else's TWEET is a deliberate signal that the user believes the TWEET would be of interest to his or her followers. It spreads the sentiment in the TWEET faster than if the TWEET was not retweeted. Sentiment information in social media that are retweeted may be more quickly incorporated in stock price, so it may have less of an effect on future abnormal returns.

Therefore, it is the combination of few followers and not being retweeted that leads to the greatest future impact. The sentiment in these TWEETS (sent by those with few followers and not retweeted) may take the longest to spread and thus creates the greatest potential for future abnormal returns. Therefore, it has been found that in some embodiments, sentiment information in social media about a specific firm or group of firms sent by individuals with few followers that are not retweeted may be directly related to future abnormal returns.

Thus, the sentiment information in social media about an individual firm can predict stock returns. So, in various embodiments, TWEETS were matched to specific firms. The convention in TWITTER is to precede the stock ticker symbol with a dollar sign (“$”) to indicate that a TWEET contains investment information about a firm.

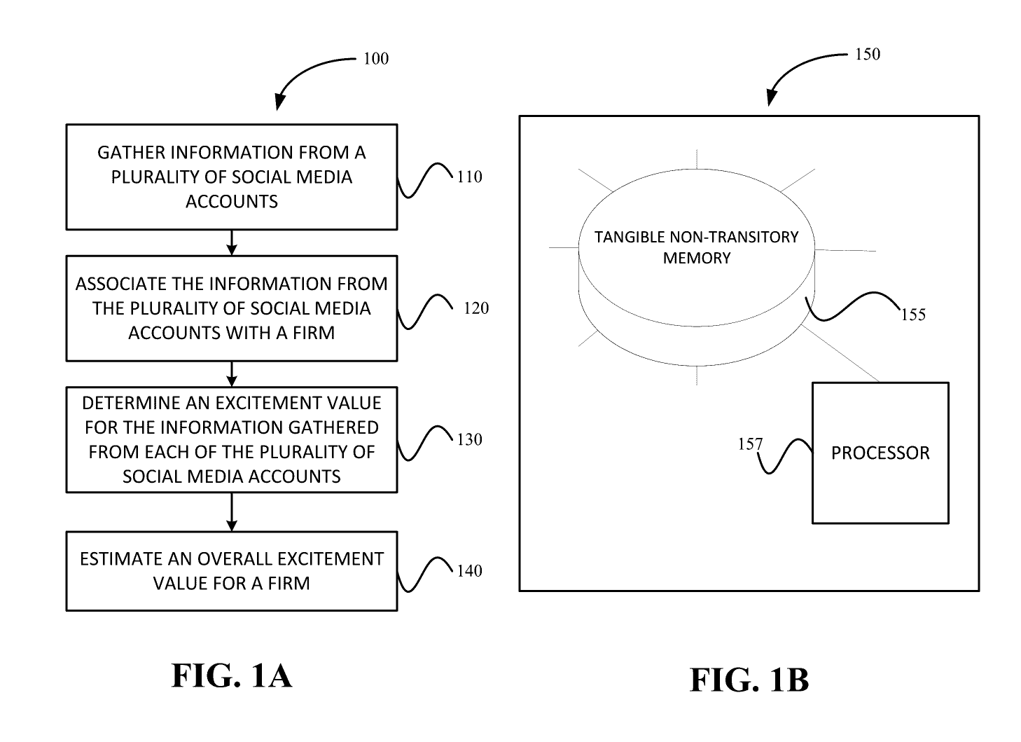

FIG. 1A illustrates a method of deriving financial information according to various embodiments. Method 100 may comprise gathering, by a processor, information from a plurality of social media accounts (step 110). Method 100 may also include associating, by the processor, the information from the plurality of social media accounts with a firm (step 120) and determining an excitement value for the information gathered from each of the plurality of social media accounts (step 130). Then, the overall excitement value for the firm may be estimated (step 140). In some embodiments, a method of trading stock may include method 100, such as determining whether to trade based on the method of claim 100.

FIG. 1B illustrates system 150 capable of performing method 100. System 150 may include a processor 157 in electrical communication with a tangible, non-transitory memory 155 having instructions that, in response to execution by the processor, cause the system 150 to gather information from a plurality of social media accounts (not shown). Processor 157 may be capable of associating the information from the plurality of social media accounts with a firm, determining an excitement value for the information gathered from each of the plurality of social media accounts, and estimating an overall excitement value for the firm.

Thus, this disclosure also includes a computer readable non-transitory storage medium bearing instructions for deriving financial information, the instructions, when executed by a processor in electrical communication with the instructions, cause the processor to perform operations comprising gathering, by the processor, information from a plurality of social media accounts, associating, by the processor, the information from the plurality of social media accounts with a firm, determining, by the processor, an excitement value for the information gathered from each of the plurality of social media accounts, and estimating, by the processor, an overall excitement value for the firm.

The overall excitement value may include various formulae and may vary across embodiments. In some embodiments, positivity may be used to determine the overall excitement value for a firm. Thus, determining the overall excitement value may include determining a positivity value of the formula

$$Posivity = log \frac{( 1 + P )}{( 1 + N )}$$

wherein P is the number of positive information and N is the number of negative information.

In some embodiments, a sentiment for the firm may also be determined. Determining the sentiment for the firm may include determining at least one of the following equations:

$$neg 1 = \frac{N}{T} ;$$

$$pos 1 = \frac{P - N}{P + N} ; or$$

$$pos 2 = log \frac{( 1 + P )}{( 1 + N )} ,$$

where P is the number of positive information, N is the number of negative information, and T is the total communication.

In various embodiments, the popularity of a social media account may be quantified, such as by the number of “friends” or “followers.” As used herein, the term “followers” may be considered to be synonymous with friends and, thus, in various embodiments it does not matter the specific term used by the social media platform. For example, a FACEBOOK account with less than 1,000 friends would also be considered to have less than 1,000 followers. The number of followers is not particularly limited so long as the market prices are not able to quickly incorporate the social media content regarding a particular firm, industry, or segment of the economy. In various embodiments, each of the plurality of social media accounts may have less than 1,000 followers, each of the plurality of social media accounts may have less than 500 followers, or each of the plurality of social media accounts may have less than 200 followers.

Also, in some embodiments, methods may include determining whether the information from each of the plurality of social media accounts was republished by another social media account. As used herein, the term “republishing” can include any form of social media that references social media content from another social media account. This can include references that include agreement with or support—such as sharing, liking, or re-TWEETS—or disapproval, such as disliking or down-voting. Furthermore, in various indicating agreement or disapproval may be symbolic.

The firm is not particularly limited and may be a single firm, or a plurality of firms. Thus, various embodiments include determining an excitement value for at least two firms. Moreover, in various embodiments, this may include determining an excitement value for an industry, geographical region, or both.

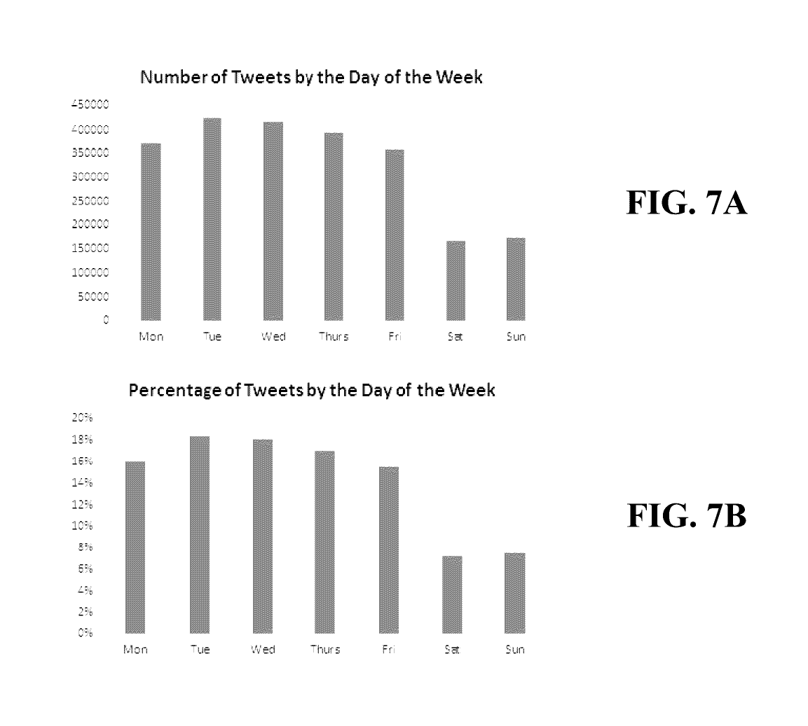

The results disclosed herein include a collection of all public TWEETS that contained the relevant $ symbol with an S&P 500 stock ticker from TWITTER using a developer account. About 3,475,428 TWEETS during the sample time period were obtained. Of all the TWEETS, 16.02% were re-TWEETS. All the TWEETS that contained more than one ticker symbol were excluded for this example. For example, a TWEET like “I also like long $AAPL @347.40 . . . and short $RIMM @62.70” would be excluded from the analysis. This produced a final sample of 2,503,385 TWEETS. An inspection of 500 randomly selected TWEETS found no TWEETS from the firm itself. FIGS. 7A and 7B show the distribution of the TWEETS by days of the week.

As used herein, the information is not particularly limited and may include alphabetic, numeric, symbolic, metacommunicative pictorial representations, or mixtures thereof. As exemplified in this disclosure, a word analysis strategy was included to demonstrate various embodiments where the alphabetic information includes words and is matched to a dictionary to determine the excitement value. Thus, each word in a TWEET was matched to a dictionary of terms to determine its sentiment. Harvard-IV dictionary (Jorgenson & Vu, 2005), which is a commonly used source for word classification in the financial content analysis of popular press articles and web news sites, was used.

However, the disclosure is not particularly limited to any one particular dictionary and, thus, various embodiments may use other well-known dictionaries (e.g., the financial dictionary of Loughran & McDonald (2011)) or may create their own custom dictionary (e.g., through machine learning).

Furthermore, positive and negative sentiment may have different effects and, thus, various embodiments may account for both positive and negative sentiment.

According to the various embodiments illustrated within counted all words in the TWEETS that had the “NEG” tag in the Harvard-IV dictionary as words that conveyed a negative sentiment. “POS” or tagged words as words conveying a positive sentiment. An analysis of 100,000 randomly selected TWEETS from our sample found 430 (0.43%) to contain emoticons.

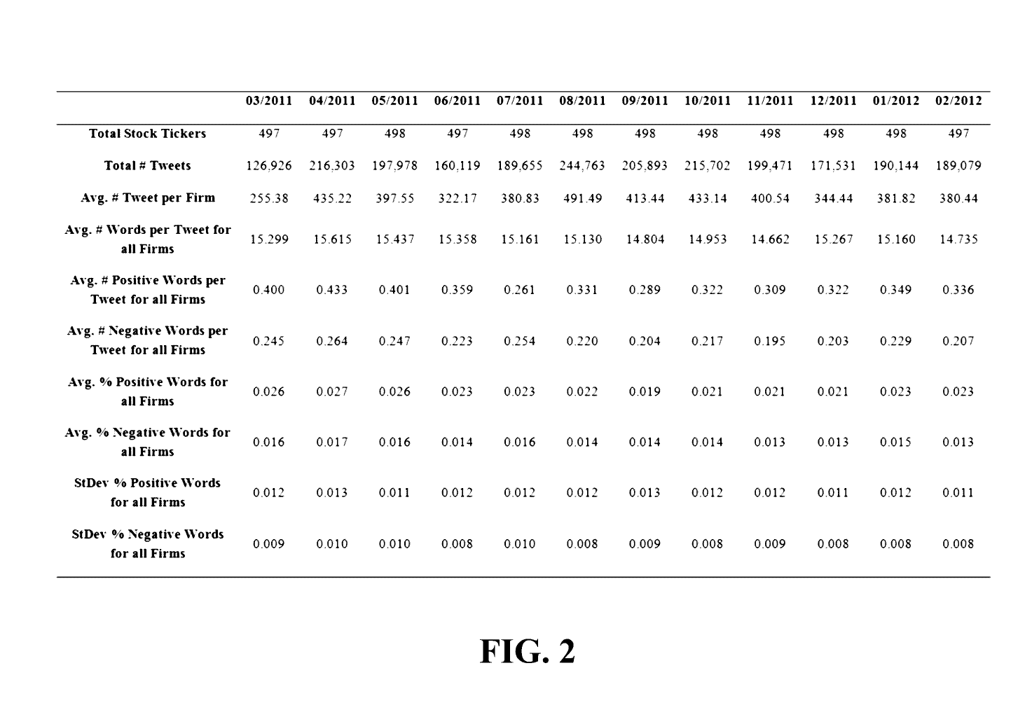

In this particular example, three separate measures were used to better model sentiment to test the relationship between sentiment and stock returns than human analysis of the TWEETS. FIG. 2 shows descriptive statistics about the TWEETS.

Daily stock returns were categorized as the dependent variable and all TWEETS for each firm on a given day was combined. The daily returns may be understood as close-to-close daily returns, so day t return was matched with firm level TWITTER content on day t up to the market close time of 4 pm Eastern Time (−4 Coordinated Universal Time (UTC)). Any TWEET that was posted after 4 pm was treated as day t+1. Three variables to measure sentiment were used and sentiment was measured as shown in Equation (1), below, where P, N, and T are the daily aggregate number of positive, negative, and total words for each day for a given firm.

$$Sentiment = \{ \begin{matrix}neg 1 ≡ \frac{N}{T} \\ pos 1 ≡ \frac{P - N}{P + N} \\ pos 2 ≡ log ( \frac{1 + P}{1 + N} )\end{matrix} \qquad ( 1 )$$

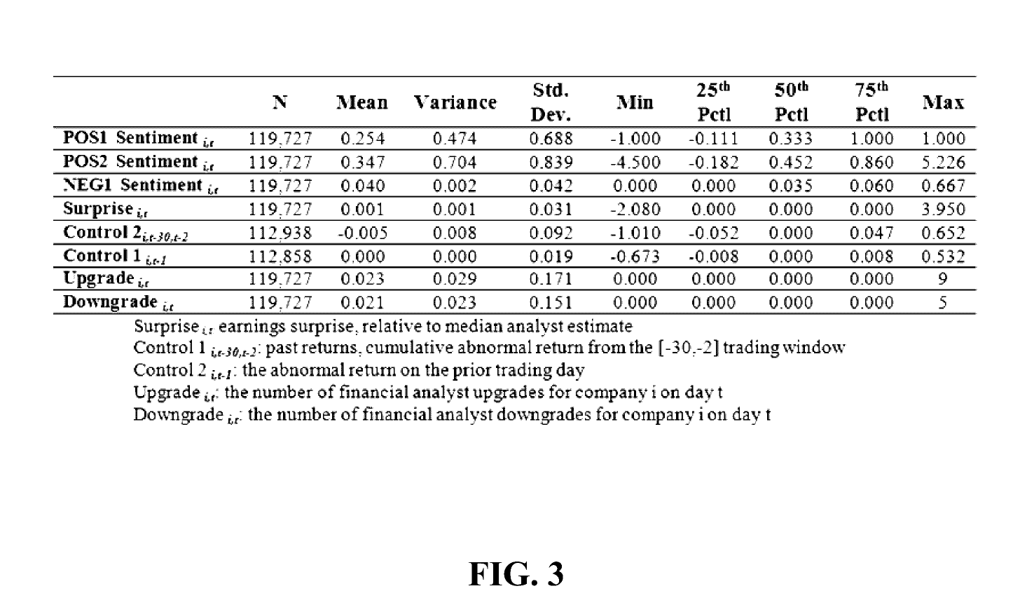

Neg1 was the ratio of the amount of negative sentiment to the total communication (positive, negative, and neither). Pos1 was a normalized ratio (on a −1 to +1 scale) of the overall positive or negative sentiment expressed (omitting words with no sentiment). Pos2 was an unstandardized ratio of positive to negative sentiment, but log adjusted to capture the potential for diminishing marginal effects. All three measures may produce similar results, but all three were included here to further demonstrate and illustrate various embodiments of the present disclosure. Descriptive statistics about the financial data can be found in FIG. 3.

Two Cumulative Abnormal Return (CAR) variables were used as control variables. The abnormal returns are computed as the raw returns (from the Center for Research in Security Prices “CRSP”) minus the size and book-to-market matched characteristic portfolio's return, which are the six portfolios based on the 30th and 70th New York Stock Exchange (“NYSE”) book to-market ratio percentiles and on the median NYSE market equity.

Earnings surprise was also included, which calculated the actual earnings per share for a given firm announced on a given day minus the median analyst earnings per share prediction. The median analyst prediction is the “Median Estimate” from Institutional Brokers' Estimate System (“IBES”) Summary.

Upgrades and downgrades were also included based on the company stock from professional stock analysts as control variables because upgrades and downgrades can influence stock returns. The number of upgrades and downgrades on the specific firm's stock on the same trading day as the TWEETS were included in these numbers to account for their effect on the stock price—as a control. Analyst recommendations were obtained from the IBES, categorized as either an upgrade or downgrade, and also counted on each trading day.

Accordingly, it was found that social media may contain sentiment information that can predict future returns. Furthermore, it was found that the speed of information dissemination was reflected by the number of followers and that retweet history influences future returns.

Regarding the speed of information dissemination, the following equation was used:

CARⁱₜ₊ₙ=α+β₀sentimentᵤ_{ₜ}ⁱ+β₁sentimentₒ_{ₜ}ⁱ+γCV+ε, (2)

where CARₜ₊ₙⁱ is the cumulative abnormal return about firm i from day t+1 to day t+n, sentimentᵤ_{ₜ}ⁱ is the sentiment about firm i on day t expressed information in social media from users with a number of followers at or under a given threshold, sentimentₒ_{ₜ}ⁱ is the sentiment about firm i on day t expressed information in social media from users with a number of followers over a given threshold and CV are five control variables, as described above: past returns (cumulative abnormal return from the [−30,−2] trading window (CAR_{t-30,t-2}ⁱ) (from 30 to two days prior to the day of interest), the abnormal return on the prior day (day −1), (CAR_{t-1,t-1}ⁱ), earnings surprise, upgrades, and downgrades.

Equation (2) above examines future abnormal returns for days 1 to n after the TWEETS were made. Three time periods were chosen: next day returns (i.e., n=1), next-day-to-10th-day returns (i.e., n=10) and next-day-to-20th-day returns for a longer view (i.e., n=20). These are trading days, so 10 days is approximately two weeks, and 20 days is approximately one month.

The impact of the number of followers was examined by testing that β₀ was positive when sentiment is pos1 or pos2 and negative when sentiment is neg1 for the different trading periods. Thus, TWEETS were split into two groups based on the number of followers of the Tweeters, those with many followers and those with few followers. Two break points (171 and 1,000) are illustrated for assigning TWEETS into groups with few followers and many followers. This produced the analysis of “few” and “many” followers (96%-4% split). The sample sizes here were 48,538 for 171 followers and 47,840 for 1000 followers.

The combined impact of number of followers and retweets was examined by dividing the TWEETS into four groups: over the number of followers and retweeted; over the number of followers and not retweeted; under the number of followers and retweeted; and under the number of followers and not retweeted. The same two break points (171 and 1,000) was used as the threshold for assigning TWEETS into groups with few followers and many followers. The sample sizes here were 8,245 for 171 followers and 9,014 for 1000 followers. As a robustness check, a separate analysis treating missing values as zero emotion (which produced sample sizes of 83,891 and 60,835, respectively) was run and it found the same pattern of results for 171 followers while the pattern of results for 1000 followers matched the pattern for 171 followers.

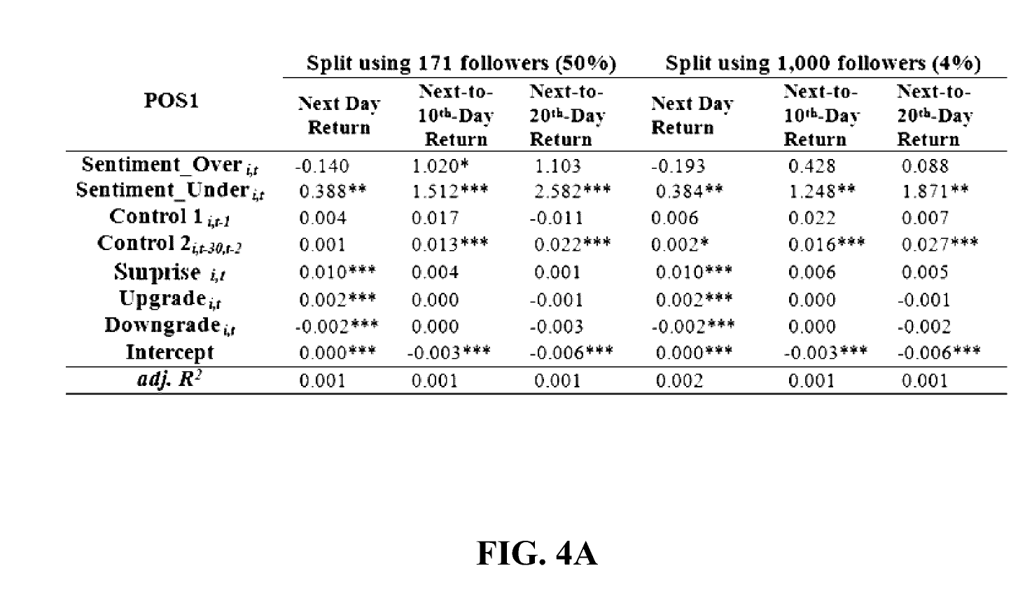

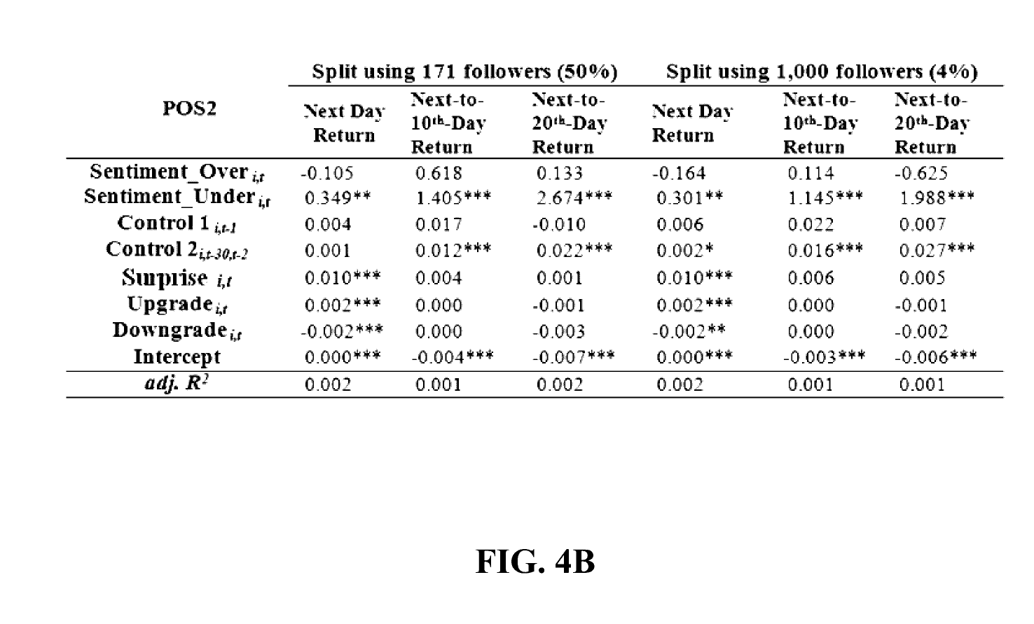

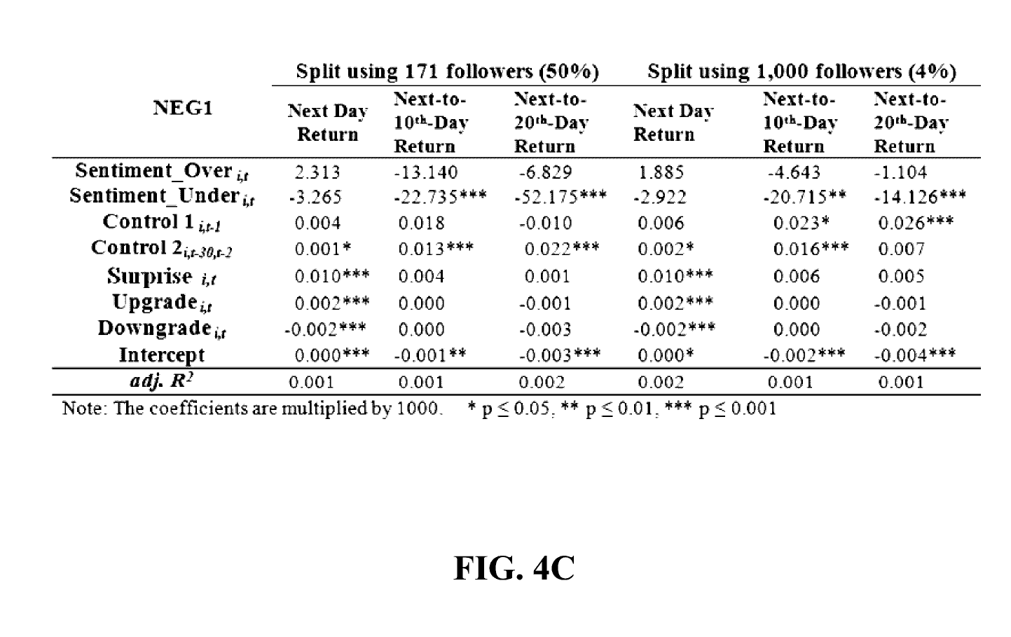

FIGS. 4A, 4B, and 4C show that with the median split (over and under 171 followers), the beta coefficients on under 171 followers are significant—for pos1, pos2, and neg1 respectively—for all three time periods (next day, next-to-10th day, and next-to-20th day), except for next day returns for neg1. The split using 1000 followers (4%-96%), also illustrated the same pattern. Thus, the number of followers may impact returns on stock as shown in FIG. 4A-4C.

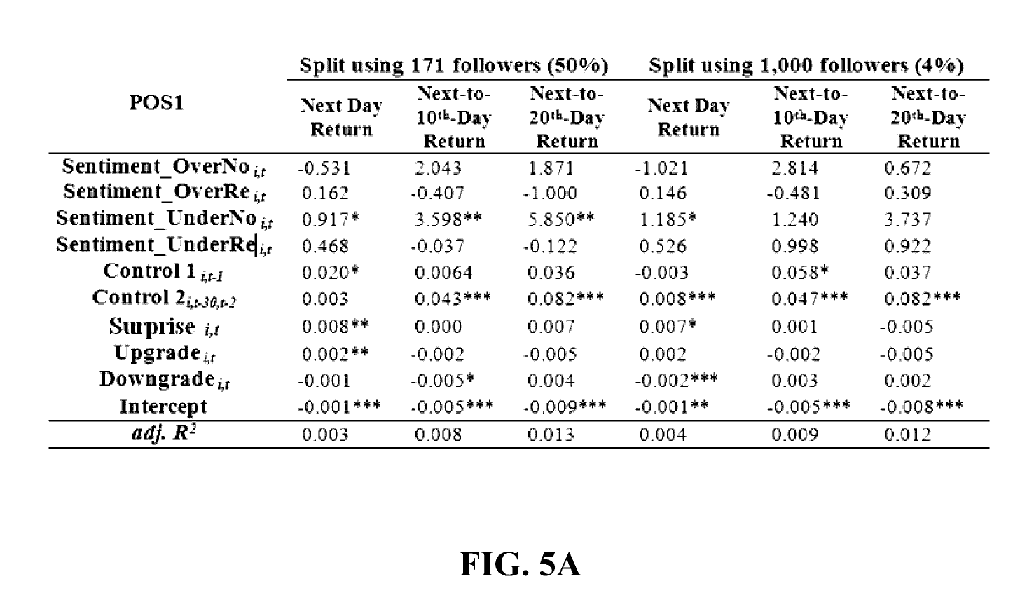

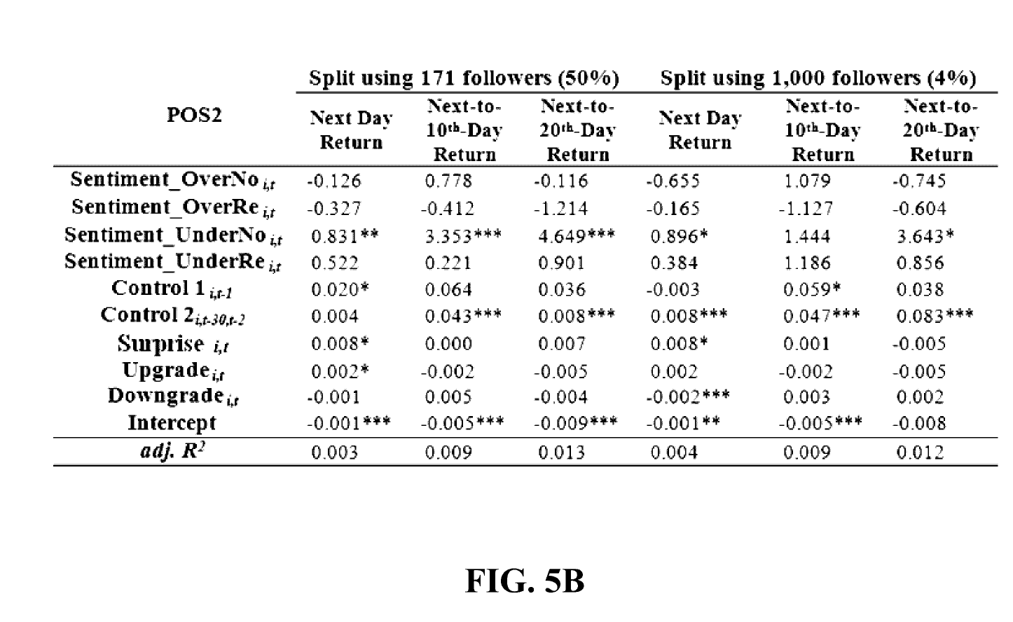

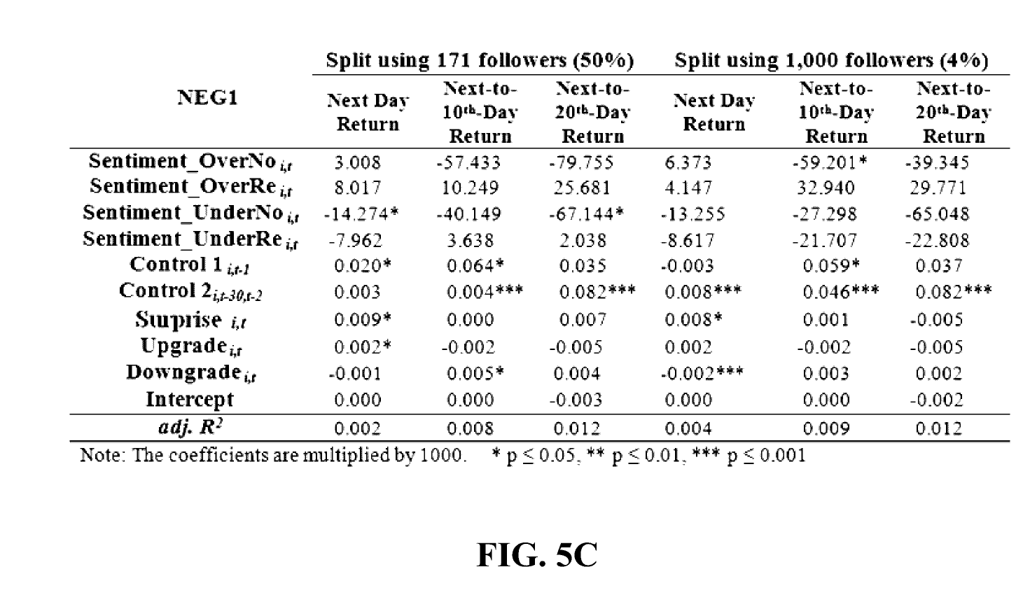

Future abnormal returns were also found to be directly related to the sentiment information in social media from users with few followers that are not shared or republished (e.g., FIGS. 5A, 5B, and 5C illustrate that with the median split (over and under 171 followers), the beta coefficients on the sentiment information in social media from those with under 171 followers that were not retweeted are significant and that for all three measures (pos1, pos2, and neg1, which are illustrated in FIGS. 5A, 5B, and 5C respectively) for all three time periods (next day, next-to-10th day, and next-to-20th day), except for next-to-10th day returns for neg1. The split using 1000 followers (4%-96%), shows a slightly different pattern.

These results show that the speed of sentiment diffusion affects future return predictability. When sentiment spreads the slowest (e.g., TWEETS sent by those with fewer than the median number of followers (less than 171) that are not retweeted), there is the greatest return predictability.

To illustrate that various embodiments disclosed herein can yield a profitable trading strategy two equally weighted portfolios were constructed: one long and one short. At the close of each trading day, the sentiment in that day's TWEETS about specific firms using pos2 were analyzed. Firms in the top 10% were purchased and firms in bottom 10% were sold short. Not all firms receive TWEETS each day, so the number of firms varies from day to day. Three different holding periods (1 day, 10 days, and 20 days) were used and at the end of the holding periods, the long positions and the short positions were closed out. Since long and short positions were simultaneously taken, no market return as a control was needed because any rise or fall in the market as a whole is controlled for by the simultaneous long and short positions.

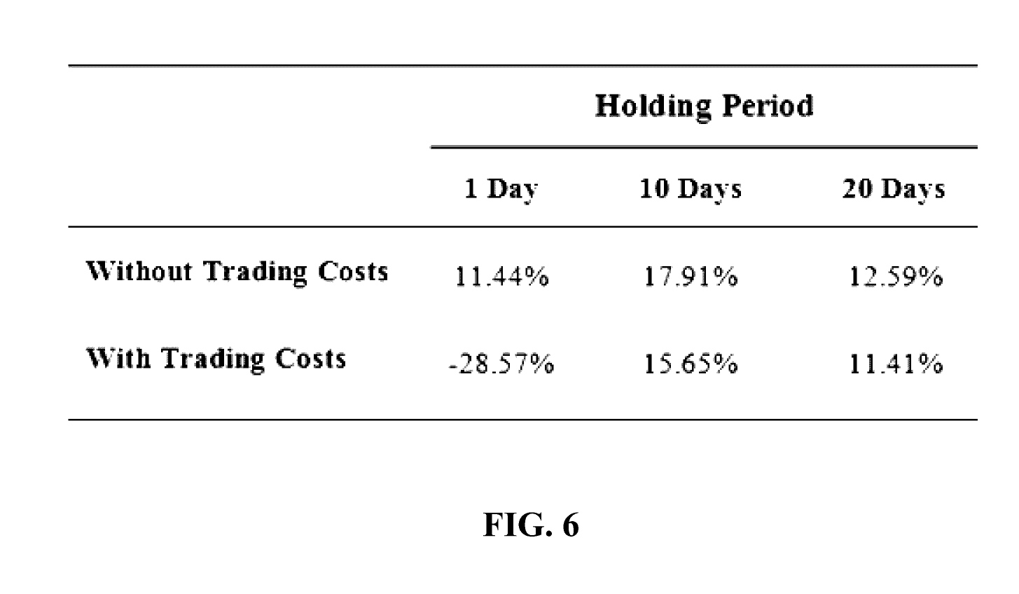

FIG. 6 presents the annualized returns of the trading strategy with and without trading costs for the three different holding periods. It was assumed that round trip trading costs of 10 basis points (i.e., the total cost to buy and sell). The 1-day holding period produces positive returns, but because the strategy executes trades every day, the returns become negative after including trading costs. The trading strategies using 10- and 20-day holding periods produce significant positive returns, both before and after trading costs. The results in FIG. 6 show that a trading strategy with a 10- or 20-day holding period that balances long and short positions results in significant and meaningful positive returns.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. §112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method of deriving financial information comprising:
gathering, by a processor, information from a plurality of social media accounts;
associating, by the processor, the information from the plurality of social media accounts with a firm;
determining an excitement value for the information gathered from each of the plurality of social media accounts; and
estimating an overall excitement value for the firm.

2. The method of claim 1, wherein each of the plurality of social media accounts has less than 1,000 followers.

3. The method of claim 1, wherein each of the plurality of social media accounts has less than 500 followers.

4. The method of claim 1, further comprising determining whether the information from each of the plurality of social media accounts was republished by another social media account.

5. The method of claim 1, further comprising determining an excitement value for at least two firms.

6. The method of claim 5, further comprising determining an excitement value for an industry.

7. The method of claim 1, wherein the information includes alphabetic, numeric, symbolic, metacommunicative pictorial representations, or mixtures thereof.

8. The method of claim 7, wherein the alphabetic information includes words and is matched to a dictionary to determine the excitement value.

9. The method of claim 8, wherein the estimating the overall excitement value for the firm includes determining a positivity value of the formula
$$Posivity = log \frac{( 1 + P )}{( 1 + N )}$$
wherein P is the number of positive information and N is the number of negative information.

10. The method of claim 8, wherein the estimating the overall excitement value for the firm includes determining a sentiment for the firm, wherein the determining the sentiment for the firm includes determining at least one of the following equations:
$$neg 1 = \frac{N}{T} ;$$
$$pos 1 = \frac{P - N}{P + N} ; or$$
$$pos 2 = log \frac{( 1 + P )}{( 1 + N )} ,$$
where P is the number of positive information, N is the number of negative information, and T is the total communication.

11. A method of trading stocks, comprising determining whether to trade based on the method of claim 1.

12. The method of claim 11, wherein the determination is based on a period within twenty calendar days.

13. A system for deriving financial information comprising:
a processor in electrical communication with a tangible, non-transitory memory having instructions that, in response to execution by the processor, cause the processor to gather information from a plurality of social media accounts;
associate the information from the plurality of social media accounts with a firm;
determine an excitement value for the information gathered from each of the plurality of social media accounts; and
estimate an overall excitement value for the firm.

14. The system of claim 13, wherein the estimation of the overall excitement value for the firm includes determining, by the processor a positivity value of the formula
$$Posivity = log \frac{( 1 + P )}{( 1 + N )}$$
wherein P is the number of positive information and N is the number of negative information.

15. The system of claim 13, wherein the estimating the overall excitement value for the firm includes determining a sentiment for the firm, wherein the determining the sentiment for the firm includes determining at least one of the following equations:
$$neg 1 = \frac{N}{T} ;$$
$$pos 1 = \frac{P - N}{P + N} ; or$$
$$pos 2 = log \frac{( 1 + P )}{( 1 + N )} ,$$
where P is the number of positive information, N is the number of negative information, and T is the total communication.

16. The system of claim 13, wherein each of the plurality of social media accounts has less than 1,000 followers.

17. The system of claim 13, wherein each of the plurality of social media accounts has less than 171 followers.

18. The system of claim 13, wherein the non-transitory memory causes the processor to determine whether the information from each of the plurality of social media accounts was republished by another social media account.

19. A computer readable non-transitory storage medium bearing instructions for deriving financial information, the instructions, when executed by a processor in electrical communication with the instructions, cause the processor to perform operations comprising:
gathering, by the processor, information from a plurality of social media accounts;
associating, by the processor, the information from the plurality of social media accounts with a firm;
determining, by the processor, an excitement value for the information gathered from each of the plurality of social media accounts; and
estimating, by the processor, an overall excitement value for the firm.

20. The computer readable non-transitory storage medium of claim 20, wherein each of the plurality of social media accounts has less than 1,000 followers.
